(19) United States
(12) Patent Application Publication
(10) Pub. No.: US 2023/0088561 A1
(43) Pub. Date: Mar. 23, 2023

(54) SYNTHETIC DATA GENERATION IN FEDERATED LEARNING SYSTEMS

(71) Applicant: Telefonaktiebolaget LM Ericsson (publ), Stockholm (SE)

(72) Inventors: Selim ICKIN, Stocksund (SE); Jalil TAGHIA, Stockholm (SE); Konstantinos VANDIKAS, Solna (SE); Farnaz MORADI, Stockholm (SE); Wenfeng HU, Täby (SE)

(21) Appl. No.: 17/908,308

(22) PCT Filed: Mar. 2, 2021
(86) PCT No.: PCT/SE2021/050172

§ 371 Date: Aug. 31, 2022

Related U.S. Application Data
(60) Provisional application No. 62/984,090, filed on Mar. 2, 2020.

(51) Int. Cl. G06N 20/20; G06N 3/08

(52) U.S. Cl. CPC G06N 20/20; G06N 3/08

(57) ABSTRACT

A method of generating a synthetic training dataset for training a machine learning model using an original training dataset including a plurality of features includes selecting a feature cᵢ of the original training dataset as a target vector yᵢ, selecting remaining features of the original training dataset as a set of training input vectors X_{\i}, where X_{\i} includes all features of the training dataset other than a feature corresponding to the selected feature cᵢ, and training a prediction model f(yᵢ|X_{\i}). The method generates an estimate y′ᵢ of the target vector yᵢ by applying the prediction model to the set of training vectors X_{\i}, and inserts a synthetic feature c′ᵢ corresponding to the estimate y′ᵢ of the target vector yᵢ into a synthetic training dataset.

### BACKGROUND

The present disclosure relates to machine learning and artificial intelligence. In particular, the present disclosure relates to generation of synthetic data for training machine learning models.

In recent years, there has been increasing interest in the use of Machine Learning (ML) techniques for Quality of Experience (QoE) modeling due to the increasingly complex interdependence and high dimensionality of features that are important to QoE models.

In QoE studies, datasets that can be used to train ML models are typically collected through both time- and energy-consuming user studies. Such datasets include not only Quality of Service (QoS) metrics, but also information about a user's perceived quality of experience on applications and services. At least some of the subjective data includes important factors for the model outcome, such as user background and application usage behaviour.

Training ML models with acceptable accuracy requires the availability of large training datasets. Due to the sensitive nature of many user datasets that are used to evaluate QoE, such datasets are not easily shared amongst QoE researchers, often due to restrictions such as the General Data Protection Regulation (GDPR) and intellectual property rights (IPR). Such restrictions often make it difficult for training datasets to be validated or reused in other QoE studies.

One way of handling this limitation is through the use of Collaborative Learning or Federated Learning (FL) techniques in which collaborators exchange and aggregate model parameters without exchanging the underlying training data that was used to obtain the model parameters. FIG. 1 illustrates a FL model in which a master node 100 controls the training of an ML model by N workers 200-1 to 200-N using locally available training datasets that include real training datasets S. Different training datasets S may be available to each of the workers 200-1 to 200-N. The model parameters are provided to the master node 100 via a message bus 110. The master node 100 aggregates the model parameters (for example, by averaging the model parameters) and provides the aggregated model parameters to the workers 200-1 to 200-N. The workers 200-1 to 200-N can then use the aggregated model parameters to refine their local models. This process is iterative as model parameters are repeatedly trained, shared, aggregated and distributed until the local model achieves an acceptable performance level. This approach has been shown to achieve similar performance compared to conventional approaches in which data is collected and trained in a centralized manner.

The FL approach requires that participating collaborators perform up to some acceptable starting accuracy, as there need to be many iterations of exchanging model parameters between the collaborating entities. More iterations require more network resources, which increases the cost of training. The problems of poor starting accuracy and high network footprint can be addressed by using synthetic but realistic training data to supplement the local workers' training datasets.

Larger training datasets help to train more robust generic machine learning models. In particular, large amounts of training data rare needed to train Neural Networks. In CL/FL, the most widely used algorithms are based on Neural Network models. In the cases where there is a limited amount of data to train a Neural Network, it is known to generate synthetic datasets with other ensembled algorithms, such as Random Forest models, that can generate structured tabular datasets.

Generative models can be used to generate synthetic training data from a small representative training dataset by interpolating/extrapolating the small dataset to a larger training dataset. This enables the development/training of more robust and/or generic machine learning models. Hence, the benefit of using a generative model to create synthetic training data is not only applicable in the field of FL, but can also be used to develop more robust machine learning models in general. This approach may be particularly valuable in the case of edge computing where worker models are separated/isolated from one another and must be trained in isolation.

### SUMMARY

Some embodiments provide a method of generating a synthetic training dataset for training a machine learning model using an original training dataset including a plurality of features. The method includes selecting a feature cᵢ of the original training dataset as a target vector yᵢ, selecting remaining features of the original training dataset as a set of training input vectors X_{\i}, where X_{\i} includes all features of the training dataset other than a feature corresponding to the selected feature cᵢ, and training a prediction model f(yᵢ|X_{\i}). The method generates an estimate y′ᵢ of the target vector yᵢ by applying the prediction model to the set of training vectors X_{\i}, and inserts a synthetic feature c′ᵢ corresponding to the estimate y′ᵢ of the target vector yᵢ into a synthetic training dataset.

The method may further include repeating, for a plurality of features of the original training dataset, operations of selecting a feature of the training dataset, selecting remaining features of the training dataset, training the prediction model, generating the estimate of the target vector and inserting the synthetic feature into the synthetic training dataset.

The features may be provided as columns in a table.

The prediction model may include a bagging or boosting algorithm, such as a random forest prediction model or a gradient boosting tree model.

Generating the estimate y′ᵢ of the target vector yᵢ may include running an inference on the prediction model using the set of training vectors X_{\i}.

Generating the estimate y′ᵢ of the target vector yᵢ may include generating an estimate y′ᵢ of the target vector yᵢ by applying the prediction model as f(X_{\i})->y′ᵢ.

The method may further include appending the synthetic training dataset to the training dataset to form a hybrid training dataset and training a machine learning model using the hybrid training dataset. Appending the synthetic training dataset to the training dataset to form the hybrid training dataset training the machine learning model are performed in response to an indication from a master node in a federated learning system.

Training the machine learning model may include generating trained weights for a neural network, the method further including transmitting the trained weights to the master node.

The method may further include providing a preliminary training dataset, splitting the preliminary training dataset into the training dataset and a verification dataset before generating the synthetic training dataset, and verifying the neural network using the verification dataset.

The method may further include performing feature reduction on the preliminary training dataset before splitting the preliminary training dataset into the training dataset and the verification dataset.

The method may further include sorting the preliminary training dataset in descending order according to an importance of the features.

The method may further include computing a Kullback-Leibler divergence between the training dataset and the synthetic training dataset to determine a quality of the training dataset.

Generating the synthetic training dataset may be performed by a worker in a federated learning system.

The method may further include receiving message from a master node in the federated learning system, wherein the message instructs the worker node to generate the synthetic training dataset, and generating the synthetic training dataset is performed in response to the message.

The method may further include generating a quality metric that represents a quality of the synthetic training dataset, and transmitting the quality metric to the master node.

A computing device according to some embodiments is configured to perform operations including selecting a feature cᵢ of the original training dataset as a target vector yᵢ, selecting remaining features of the original training dataset as a set of training input vectors X_{\i}, where X_{\i} includes all features of the training dataset other than a feature corresponding to the selected feature cᵢ, and training a prediction model f(yᵢ|X_{\i}), generating an estimate y′ᵢ of the target vector yᵢ by applying the prediction model to the set of training vectors X_{\i}, and inserting a synthetic feature c′ᵢ corresponding to the estimate y′ᵢ of the target vector yᵢ into a synthetic training dataset.

Some embodiments provide a computing device including a processing circuit, and a memory coupled to the processing circuit. The memory includes computer readable program instructions that, when executed by the processing circuit, cause the computing device to perform operations including selecting a feature cᵢ of the original training dataset as a target vector yᵢ, selecting remaining features of the original training dataset as a set of training input vectors X_{\i}, where X_{\i} includes all features of the training dataset other than a feature corresponding to the selected feature cᵢ, and training a prediction model f(yᵢ|X_{\i}), generating an estimate y′ᵢ of the target vector yᵢ by applying the prediction model to the set of training vectors X_{\i}, and inserting a synthetic feature c′ᵢ corresponding to the estimate y′ᵢ of the target vector yᵢ into a synthetic training dataset.

A computer program according to some embodiments includes program code to be executed by processing circuitry of a computing device, whereby execution of the program code causes a computing device to perform operations including selecting a feature cᵢ of the original training dataset as a target vector yᵢ, selecting remaining features of the original training dataset as a set of training input vectors X_{\i}, where X_{\i} includes all features of the training dataset other than a feature corresponding to the selected feature cᵢ, and training a prediction model f(yᵢ|X_{\i}), generating an estimate y′ᵢ of the target vector yᵢ by applying the prediction model to the set of training vectors X_{\i}, and inserting a synthetic feature c′ᵢ corresponding to the estimate y′ᵢ of the target vector yᵢ into a synthetic training dataset.

A computer program product according to some embodiments includes a non-transitory storage medium including program code to be executed by processing circuitry of a computing device, whereby execution of the program code causes the computing device to perform operations including selecting a feature cᵢ of the original training dataset as a target vector yᵢ, selecting remaining features of the original training dataset as a set of training input vectors X_{\i}, where X_{\i} includes all features of the training dataset other than a feature corresponding to the selected feature cᵢ, and training a prediction model f(yᵢ|X_{\i}), generating an estimate y′ᵢ of the target vector yᵢ by applying the prediction model to the set of training vectors X_{\i}, and inserting a synthetic feature c′ᵢ corresponding to the estimate y′ᵢ of the target vector yᵢ into a synthetic training dataset.

A computing device according to some embodiments includes a training dataset collection module that obtains a training dataset, the training dataset including a plurality of features, and a synthetic dataset generation module that generates a synthetic training dataset by performing operations including selecting a feature cᵢ of the training dataset as a target vector yᵢ, selecting remaining features of the training dataset as a set of training vectors X_{\i}, where X_{\i} includes all features of the training dataset other than feature cᵢ, training a prediction model f(yᵢ|X_{\i}), generating an estimate y′ᵢ of the target vector yᵢ by applying the prediction model to the set of training vectors X_{\i}, and inserting a feature c′ᵢ corresponding to the estimate y′ᵢ of the target vector yᵢ into the synthetic training dataset.

The synthetic dataset generation module may be further configured to perform operations including repeating, for a plurality of features of the original training dataset, operations of selecting a feature of the training dataset, selecting remaining features of the training dataset, training the

prediction model, generating the estimate of the target vector and inserting the synthetic feature into the synthetic training dataset. The features may be provided as columns in a table.

The computing device may further include a machine learning model training module that trains a machine learning model using the synthetic training dataset.

A method of operating a master in a federated learning system including a plurality of workers that communicate with the master via a message bus includes transmitting, via the message bus, a message to at least one of the workers instructing the at least one worker to generate synthetic training data, and receiving, via the message bus, model parameters of a machine learning model from the at least one worker that were generated using the synthetic tabular training data.

The model parameters received from the worker may include trained neural network weights.

The method may further include receiving from the at least one worker a set of preliminary neural network weights that were trained without using the synthetic training data, and evaluating the set of preliminary neural network weights. Transmitting the message to the at least one worker instructing the at least one worker to generate synthetic tabular training data may be performed in response to evaluating the set of preliminary neural network weights.

The method may further include, after instructing the at least one worker to generate the synthetic training data, receiving a quality metric from the at least one worker, wherein the quality metric measures a quality of the synthetic training dataset, and instructing the worker to proceed with training a machine learning model using the synthetic training dataset in response to the quality metric.

The machine learning model may include a neural network.

A master node in a federated learning system configured to perform operations of transmitting, via a message bus, a message to at least one of a plurality of workers instructing the at least one worker to generate synthetic training data, and receiving, via the message bus, model parameters of a machine learning model from the at least one worker that were generated using the synthetic tabular training data.

A master node in a federated learning system includes a processing circuit, and a memory coupled to the processing circuit, wherein the memory includes computer readable program instructions that, when executed by the processing circuit, cause the master node to perform operations of transmitting, via a message bus, a message to at least one of a plurality of workers instructing the at least one worker to generate synthetic training data, and receiving, via the message bus, model parameters of a machine learning model from the at least one worker that were generated using the synthetic tabular training data.

Some embodiments provide a computer program including program code to be executed by processing circuitry of a computing device, whereby execution of the program code causes a computing device to perform operations of transmitting, via a message bus, a message to at least one of a plurality of workers instructing the at least one worker to generate synthetic training data, and receiving, via the message bus, model parameters of a machine learning model from the at least one worker that were generated using the synthetic tabular training data.

A computer program product according to some embodiments includes a non-transitory storage medium including program code to be executed by processing circuitry of a computing device, whereby execution of the program code causes the computing device to perform operations of transmitting, via a message bus, a message to at least one of a plurality of workers instructing the at least one worker to generate synthetic training data, and receiving, via the message bus, model parameters of a machine learning model from the at least one worker that were generated using the synthetic tabular training data.

The initial training accuracy of workers in a FL system may be increased when synthetic data generated according to some embodiments is used for training. This may result in faster convergence fewer training cycles, thereby reducing network footprint and/or energy consumption.

### BRIEF DESCRIPTION OF THE DRAWINGS

FIG. 1 illustrates a federated learning model including a master node and workers.

FIG. 2 illustrates federated training methods according to some embodiments.

FIG. 3 illustrates generation of a synthetic dataset according to some embodiments.

FIG. 4 illustrates operations of systems/methods for generating of a synthetic dataset according to some embodiments.

FIG. 5 illustrates signal flows associated with operations of systems/methods for generating of a synthetic dataset according to some embodiments.

FIG. 6 is a flowchart that illustrates operations of systems/methods for generating of a synthetic dataset according to some embodiments.

FIG. 7A illustrates components of a worker according to some embodiments.

FIG. 7B illustrates functional modules stored in a memory of a worker according to some embodiments.

FIG. 8 illustrates components of a master node according to some embodiments.

FIG. 9 illustrates AUC and MAE scores obtained from the Machine Learning models trained with an original training set and with synthetic and original training sets.

FIGS. 10, 11 and 12 are graphs that illustrate improvement in testset accuracy for three different datasets when using LOO based tabular data generation.

FIG. 13 is a snapshot of computation time during the LOO data synthesis method according to some embodiments.

FIG. 14 is a snapshot CPU utilization histogram is during the LOO data synthesis method according to some embodiments.

FIG. 15 is a snapshot of software interrupts during the LOO data synthesis method according to some embodiments.

FIG. 16 illustrates federated training systems and methods according to further embodiments.

### DESCRIPTION OF EMBODIMENTS

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Synthetic data generation methods have been employed in the area of audio, image and text synthesis. Synthetic data generation has been less successful in the area of tabular data generation, however. Given that the majority of QoE datasets are tabular and consist of continuous and discrete features with multi-modal, or different distributions, there is a need for improved synthetic data generation methods for generation of synthetic tabular data.

Generative Adversarial Networks (GANs), which work based on a combination of Neural Network algorithms and other algorithms, such as game theory, are good candidates for synthetic data generation. GANs consist of generative and discriminator models that are trained in turns. First, a discriminator model is trained with real samples to differentiate between real and synthetic data samples. Next, a generative model is trained that tries to generate synthetic but realistic samples. The realistic samples are fed into the discriminator model. The goal of the generative model is to fool the discriminator model. The effectiveness of a generative model is measured by a generative loss, while the effectiveness of the discriminator model is measured by a discriminative loss. The generative model is trained such that the generative loss would decrease while the discriminator model's loss increases. Many different GAN techniques exist that are capable of generating synthetic tabular datasets. For example the CT-GAN technique has a pre-processing phase that consists of a variational Gaussian Mixture Model for mode detection of features, and conditional generator model that prevents mode collapse.

TableGAN is another GAN-based method that is used to generate synthetic tables that are similar to the original (real) tables. GAN-based techniques are hard to train due to the known challenges of training a deep neural network plus additional challenges present in game theory. In addition to the increased model engineering time, the training time, and resource consumption during the training time are often demanding. The principle of GAN is that both the discriminator and generative models should be just good enough such that each party can train each the other one well. If a generative model is too poor, it becomes difficult to generate realistic synthetic samples. Hence, it is typically preferred for the discriminator model to be good in the beginning, while the generative model performs poorly. Over time, the generative model becomes better while the discriminator model performance becomes poorer, but only up to some point. If the discriminator is poor, then generative model will be trained with noisy loss values, hence the training will not benefit generative model. The main challenge of the GAN-based approach is to monitor the performance of the models and decide when to stop training. If the training is not stopped at the right time, it could result in model collapse.

These and other challenges are addressed by embodiments described herein, which provide a non-GAN-based approach to the generation of synthetic datasets.

Some embodiments described herein provide a method for generating tabular synthetic QoE dataset that can be used to improve existing local QoE model performance in a Federated Learning environment that may reduce the network footprint over the communication channel between the collaborators. The method described herein may be described as a leave-one-out (LOO) algorithm for tabular synthetic data generation.

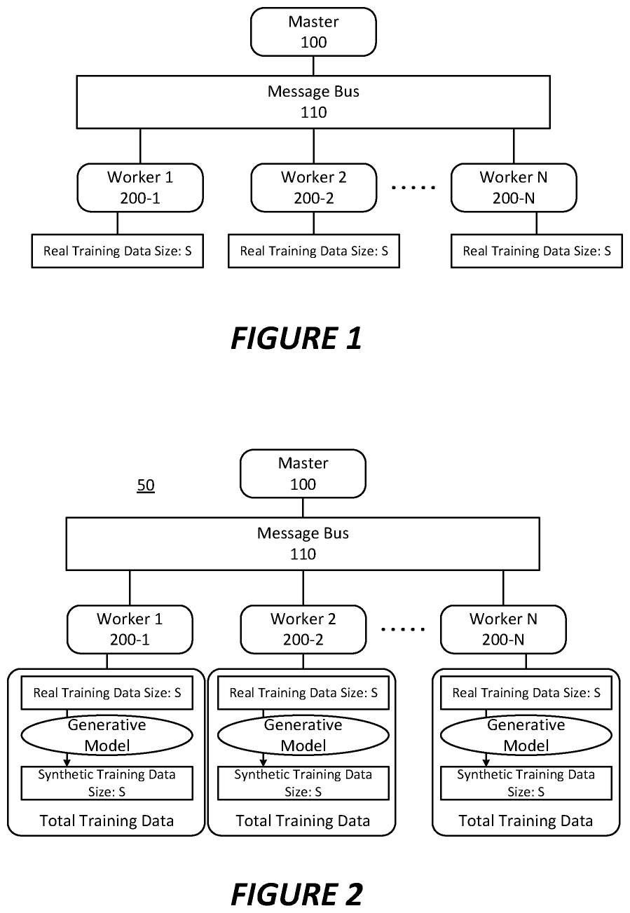

Federated training methods according to some embodiments are illustrated in FIG. 2, which shows a Federated Learning system 50 with a similar structure as the one shown in FIG. 1. In FIG. 2, a synthetic training data generation process is used by each worker 200-1 to 200-N to create realistic, training datasets S′ that include similar but not identical training samples conditioned on the original training datasets S. That is, each worker 200-1 to 200-N, which has access to a real training dataset of size S, uses a generative model to generate a synthetic training dataset S′ having the same size as the real training dataset S. The real and synthetic datasets may be combined into a new training dataset of size 2S.

By increasing size of the dataset used to train the model, the accuracy of the model may be improved. In a Federated Learning environment, increasing the initial model accuracy and/or decreasing the required number of iterations of communication between collaborators can improve model accuracy, decrease training time and/or reduce the network footprint needed for model training.

In particular, some embodiments provide systems and/or methods for generating a synthetic but realistic training tabular dataset in order to improve Neural Network (NN) based model performance in situations where available training data is limited. As a result, higher starting model performance may be achieved in a Federated Learning environment which can result in faster model convergence. Moreover, even when Federated Learning is not employed, the availability of synthetic data can improve the model performance in situations where suitable training data is otherwise difficult to obtain.

Some embodiments described herein provide a light-weight method for generating a synthetic tabular dataset that might contain a mix of continuous and categorical columns empowered by Boosting and/or Bagging methods that are known to be superior in structured tabular datasets.

In particular, some embodiments provide a method of generating a synthetic training dataset for training a machine learning model. The method may be referred to as a leave-one-out (LOO) method. In the LOO method, an initial (real) training dataset is provided in tabular form. The training dataset is provided in the form of a table that includes a plurality of columns that correspond to respective features of a system. According to some embodiments, each column cᵢ of the training dataset is selected as a target vector yᵢ. Remaining columns of the training dataset are selected as a set of training vectors X_{\i}, where X_{\i} includes all features of the training dataset other than a feature corresponding to the column cᵢ. The method then trains a prediction model f(yᵢ|X_{\i}) that predicts values of the elements of target vector yᵢ based on the training vectors X_{\i}.

The method generates an estimate y′ᵢ of the target vector yᵢ by applying the prediction model to the set of training vectors X_{\i}. Once the estimate y′ᵢ of the target vector yᵢ is generated, the method inserts a column c′ᵢ corresponding to the estimate y′ᵢ of the target vector yᵢ into a synthetic training dataset.

This process is repeated until all of the columns of the training dataset have been reproduced with synthetic data in the synthetic training dataset. The synthetic dataset may be combined with the training dataset, effectively doubling the size of the training dataset.

Some embodiments described herein may have one or more advantages.

The initial training accuracy of workers in a FL system may be increased when synthetic data generated according to some embodiments is used for training. This may result in faster convergence fewer training cycles, thereby reducing network footprint and/or energy consumption.

In non-FL cases, i.e., cases where neither sharing of data nor sharing of neural weights is possible, some embodiments can nevertheless provide additional training data based on a known data distribution. The accuracy of an isolated NN model accuracy may thereby be improved.

Since data is generated using a bagging or boosting model according to some embodiments, the approaches described herein can be considered as light-weight in terms of computation time and model engineering efforts as compared to GAN-based approaches, since GAN-based approaches necessitate at least 2 NN models to be trained alternatively.

Since the model generation used in some embodiments makes the training dataset a bit noisy, a model trained with the generated dataset is expected to be more robust to over-fitting issues.

Finally, the use of generated synthetic tabular training data samples can address privacy issues that may arise when using training data.

Some potential advantages of using the LOO method of generating synthetic training data versus using a Generative Adversarial Network (GAN) or Recurrent Neural Network (RNN) to generate synthetic training data are summarized in Table 1 below.

TABLE 1
Summary of Potential Advantages of LOO Method

| | | GAN | RNN (Recurrent |
|---|---|---|---|
| | Leave-One-Out | (Generative Adversarial | Neural |
| | (LOO) | Networks) | Network) |
| Data type | Structured Tabular | Mostly Image data | Text data |
| | data | (Conditional Tabular | |
| | | GAN is for tabular data, | |
| | | but has limitations) | |
| Computation Time | Low | High | High |
| Model engineering | Low | High | Needs large dataset, and also |
| effort | | (Hard to train due to | hard to tune model and |
| (e.g., Model Tuning) | | high number of | highly sensitive to the time |
| | | parameters to tune) | window taken. |
| | | E.g., embedding | |
| | | dimensions, 2D data | |
| | | generative model | |
| | | dimensions, 2D | |
| | | Discriminator model | |
| | | dimensions, l2 | |
| | | normalization scale, batch | |
| | | size, nr of epochs, nr of | |
| | | steps for each epoch | |
| Nr. ML models | One non-NN based | At least two NN models | NN-based supervised |
| involved in training | bagging or boosting | are involved are trained | learning model, where a |
| | supervised learning | alternatively until an | sequence of embedded text |
| | model | acceptable converge | is provided as input features |
| | E.g., Random Forest is | has reached to Nash | |
| | a good candidate | equilibrium | |
| CPU Utilization, hence | Low | High | High |
| energy consumption | | | |
| Parallelized | Yes (fit and predict | No | No |
| Computation | functions in Sklearn | | |
| | implementation are | | |
| | parallelized) | | |
| Preprocessing (e.g., | No | Yes | Yes |
| Normalization) of the | | | |
| data required | | | |
| Missing values are | Yes | No | No |
| handled | | | |
| Overfitting (mode | Seldom | More often | More often |
| collapse) | | | |

Some embodiments provide systems/methods that perform synthetic tabular data generation referred to as leave-one-out (LOO). Some embodiments use a bagging or boosting algorithm, such as a Random Forest algorithm, to train and generate the synthetic dataset. A Light Gradient Boosting Tree algorithm may also be used, as be since such methods are known for high performance on tabular datasets. However, Gradient Boost Machine (GBM) trees are trained sequentially and therefore are slower compared to bagging or boosting algorithms. There are also more hyperparameters to tune in GBM models compared to RF models.

To generate a synthetic dataset S′ for testing, a tabular training dataset S containing real (non-synthetic) data is provided. Initially, the dimensionality of the real dataset may be decreased by reducing the amount of input features. This may be accomplished by applying feature importance measurement (e.g., feature selection) techniques. The remaining features are then sorted with respect to the importance of the feature, with the labels in descending order from left-to-right.

The real dataset is then split into a training dataset and a test dataset. For example, the data may be randomly divided into a training dataset and a test dataset according to a predetermined percentage (e.g., 70% training, 30% test).

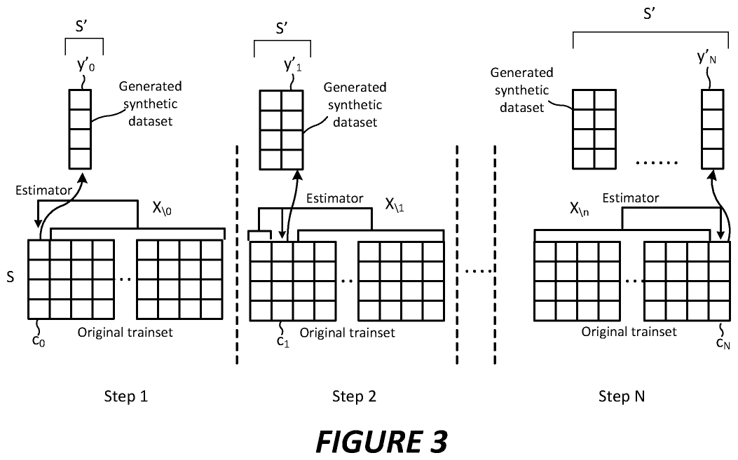

Once the training dataset has been defined, a synthetic dataset is generated as illustrated in FIG. 3. As shown in FIG. 3, beginning with column co, each column cᵢ of an original training dataset S is sequentially selected as a target vector y₀. The remaining columns of the dataset, denoted X_{\0} are used to predict a value of the target vector y₀ using an estimator function, where the predicted target vector is denoted y′₀. The predicted target vector y′₀ at each step is added to a generated synthetic dataset S′. When all N columns of the training dataset S have been processed, the synthetic dataset S′ is complete and includes predicted target vectors y′₀ . . . y′_{N} as columns.

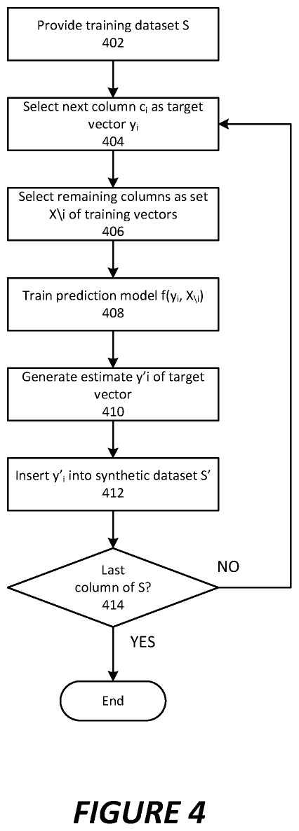

Accordingly, referring to FIG. 4, once a training dataset S has been provided (block 402) the following steps are repeated for each column in the training dataset starting from left-to-right, i.e., starting from column index 0 of the training dataset:

First, set a column index i to 0.

On the training dataset S, select the column cᵢ as a target vector yᵢ (block 404). The remaining columns of the training dataset are selected to form a set of input vectors X_{\i} (block 406). A model is then trained at block 408 that fits f(yᵢ|X_{\i}), where cᵢ stands for the column i (indexed from left to right) that is selected as the target vector yᵢ for this iteration. The “\” symbol is used for “not”, where “\” means all column indices except for column index i. The model may, for example, be a bagging or boosting algorithm, such as a Random Forest model, or a Light Gradient Boosting Tree algorithm.

Next, the method runs an inference on the model using the same training set X_{\i} to generate an estimate y′ᵢ of the target vector yᵢ via f(X_{\i})->y′ᵢ (block 410).

The estimate y′ᵢ of the target vector yᵢ is then appended as a new column in the synthetic dataset S′ (block 412).

The column index i is then incremented by 1 (i.e., the column index is shifted to the right), and the previous steps are repeated until all columns of the synthetic dataset S′ have been generated, i.e., until i=I−1; where I is the total number of columns in the original dataset.

Once all columns of the training dataset S have been processed, a tabular synthetic dataset S′ having the same size of the original training dataset S is generated.

The method may then compute a quality metric that measures a quality of the synthetic training dataset S′, such as the Kullback-Leibler (KL) divergence between the original training data set S and the synthetic dataset S′, to make sure the values are neither too small (e.g. close to 0) nor too big. A too-small distance score may indicate that the model is not creating data samples that are far enough from the original dataset, while a too-large distance may indicate that the generated dataset is very different from original dataset.

The synthetic dataset may then be appended to the original dataset to provide a larger combined training dataset. The larger combined training dataset may be used to train a NN model.

Finally, the performance of the trained model may be evaluated on the real test set.

Some embodiments described herein may be advantageously implemented to improve the operation of a Federated Learning system. For example, in some embodiments, referring again to FIG. 2, the master 100 may request that a worker 200-N to send weights only after the worker 200-N has improved its shared weights by generating synthetic training samples. In other embodiments, the worker 200-N may share a quality measurement of the synthetic training dataset, such as the KL divergence of the synthetic training dataset, with the master 100, and the master 100 can determine whether or not the worker 200-N should proceed with using the synthetic training dataset.

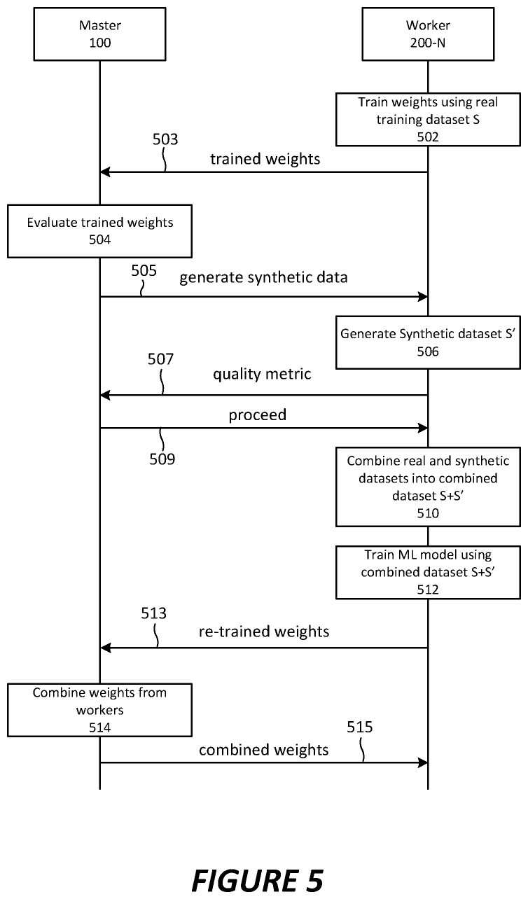

For example, FIG. 5 illustrates an example exchange between a master 100 and a worker 200-N in a federated learning system according to some embodiments. As shown therein, a worker 200-N may train a set of weights for a local ML model, such as a neural network, using a real training dataset S (block 502). The worker 200-N sends the trained weights to the master 100 in a message 503. The master 100 evaluates the trained weights at block 504, and in this example decides that the worker 200-N should use synthetic data for training, for example, to reduce a number of training iterations needed to stay below a threshold of training iterations. The master 100 indicates this to the worker 200-N vie a message 505 instructing the worker 200-N to generate synthetic training data.

At block 506, the worker 200-N generates a synthetic training dataset S′ using, for example, the methods described herein. The worker 200-N generates a quality metric for the synthetic dataset, such as the KL divergence of synthetic training dataset, and transmits the quality metric to the master 100 in a message 507. The master evaluates the quality metric and, in this example, decides that the worker 200-N should proceed with using the synthetic training dataset S′, which it indicates to the worker 200-N in a message 509.

The worker 200-N then combines the real training dataset S with the synthetic training dataset S′ at block 510 and trains the ML model using the combined dataset (S, S′) at block 512.

The worker 200-N then sends the re-trained weights to the master 100 in a message 513. The master 100 combines the re-trained weights with trained weights from other workers 200 at block 514, and transmits the combined weights to the workers 200 in a message 515.

It will be appreciated that all or only a subset of the workers 200 may be instructed to generate and use synthetic data in any given FL system in various embodiments. The decision to require synthetic data may depend on the quality of weights provided by a given worker and/or based on other considerations. For example, in some embodiments, the master 100 may set a limit on the number of training iterations allowed and may require the use of synthetic training data to ensure that the number of training iterations is under the limit.

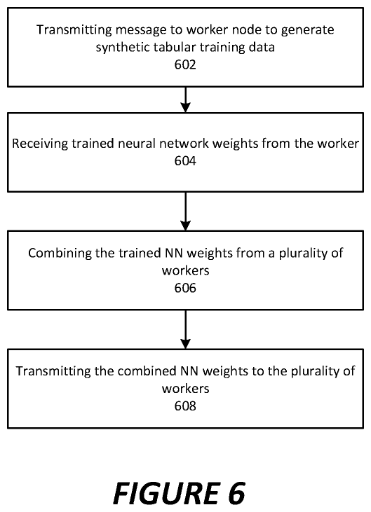

Operations according to some embodiments are illustrated in FIG. 6. Referring to FIG. 6, a method of operating a master node 100 in a federated learning system 50 according to some embodiments includes transmitting, via the message bus, a message to at least one of the workers instructing the at least one worker to generate synthetic tabular training data (block 602), and receiving, via the message bus, trained neural network weights from the at least one worker that were trained using the synthetic tabular training data (block 604). The master node combines the trained weights with trained weights provided by other workers (block 606) and transmits the combined weights to the plurality of workers (block 608).

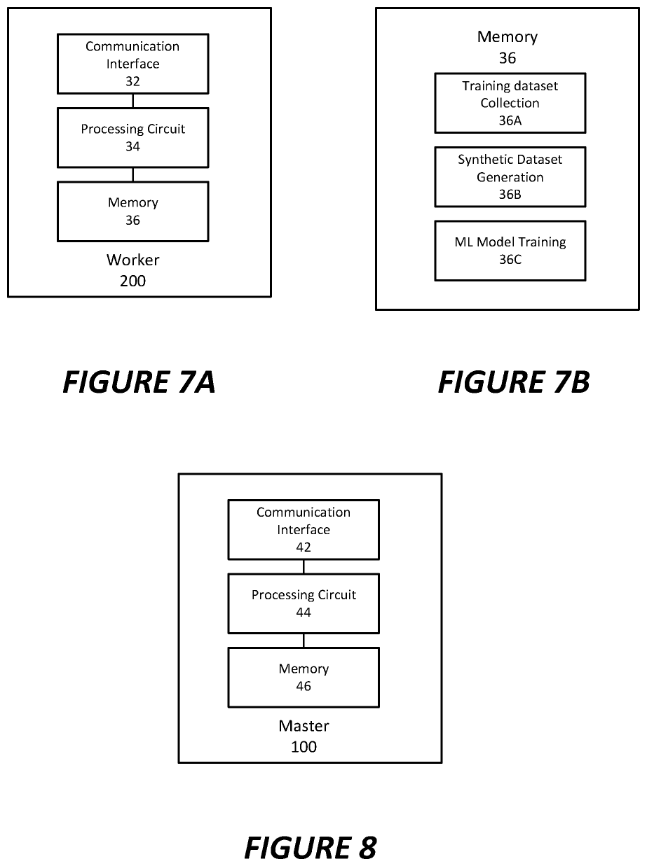

FIG. 7A is a block diagram of a device, such as a worker 200 (also referred to as a worker node 200) for generating a synthetic dataset. Various embodiments provide a device 200 that includes a processor circuit 34 a communication interface 32 coupled to the processor circuit, and a memory 36 coupled to the processor circuit 34. The memory 36 includes machine-readable computer program instructions that, when executed by the processor circuit, cause the processor circuit to perform some of the operations depicted described herein.

As shown, the device 200 includes a communication interface 32 (also referred to as a network interface) configured to provide communications with other devices. The device 200 also includes a processor circuit 34 (also referred to as a processor) and a memory circuit 36 (also referred to as memory) coupled to the processor circuit 34. According to other embodiments, processor circuit 34 may be defined to include memory so that a separate memory circuit is not required.

As discussed herein, operations of the device 200 may be performed by processing circuit 34 and/or communication interface 32. For example, the processing circuit 34 may control the communication interface 32 to transmit communications through the communication interface 32 to one or more other devices and/or to receive communications through network interface from one or more other devices. Moreover, modules may be stored in memory 36, and these modules may provide instructions so that when instructions of a module are executed by processing circuit 34, processing circuit 34 performs respective operations (e.g., operations discussed herein with respect to example embodiments).

FIG. 7B illustrates various functional modules that may be store in the memory 36 of the device 200. The modules may include a training dataset collection module 36 for obtaining a real training dataset, a synthetic dataset generation module 36B for generating a synthetic training dataset from the real training dataset as described herein, and a machine learning model training module 36C for training a machine learning model such as a neural network using the synthetic training dataset as described herein.

FIG. 8 is a block diagram of a device, such as a master 100 (also referred to as a master node 100) for generating a synthetic dataset. Various embodiments provide a device 100 that includes a processor circuit 44 a communication interface 42 coupled to the processor circuit, and a memory 46 coupled to the processor circuit 44. The memory 46 includes machine-readable computer program instructions that, when executed by the processor circuit, cause the processor circuit to perform some of the operations depicted described herein.

As shown, the device 100 includes a communication interface 42 (also referred to as a network interface) configured to provide communications with other devices. The device 100 also includes a processor circuit 44 (also referred to as a processor) and a memory circuit 46 (also referred to as memory) coupled to the processor circuit 44. According to other embodiments, processor circuit 44 may be defined to include memory so that a separate memory circuit is not required.

As discussed herein, operations of the device 100 may be performed by processing circuit 44 and/or communication interface 42. For example, the processing circuit 44 may control the communication interface 42 to transmit communications through the communication interface 42 to one or more other devices and/or to receive communications through network interface from one or more other devices. Moreover, modules may be stored in memory 46, and these modules may provide instructions so that when instructions of a module are executed by processing circuit 44, processing circuit 44 performs respective operations (e.g., operations discussed herein with respect to example embodiments).

The methods described herein are applied in multiple datasets with varying training data sizes to gather indicative results. For dataset 1 and results (KPI Degradation Prediction use case), over 100 iterations are performed with different original training datasets. The training set and the test set sizes are given in Table 2.

TABLE 2
Dataset size for each experiment

| | Original | Generated | Total | |
|---|---|---|---|---|
| | training | synthetic tabular | Training set | Testset |
| | set size | training set size | size | size |
| Dataset 0 | 400 | 800 | 1200 | 100 * 4 |
| Dataset 1 | 800 | 1600 | 2400 | 100 * 4 |
| Dataset 2 | 3200 | 6400 | 9600 | 100 * 4 |
| Dataset 3 | 7008 | 14016 | 21024 | 100 * 4 |

The KPI degradation use case dataset consists of 41 features (after further dimensionality reduction). In order to evaluate the model, four experiments are performed, each with different data sizes, where bagging or boosting algorithm is used during synthetic tabular data generation.

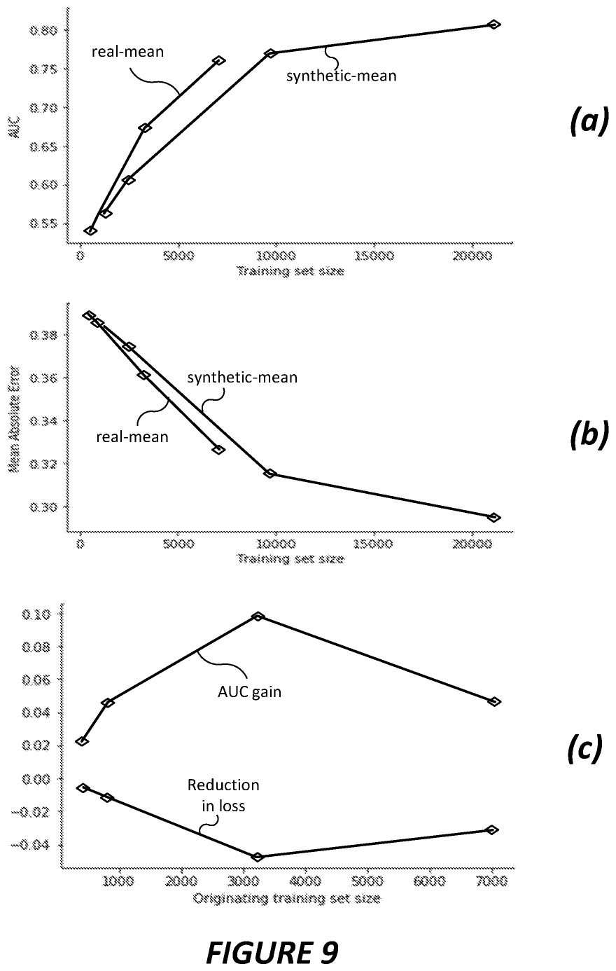

Two evaluation methods are used to quantify the benefits of the LOO approach described herein, namely, MAE (Mean Absolute Error) and Area Under the ROC Curve (AUC). FIGS. 9(a) and 9(b) illustrate the AUC and MAE scores obtained from the ML models trained with original training set and with the synthetic & original training set. The figures indicate that the ML model performance can further be improved with larger synthetically generated training data samples up to a certain extent.

The blue and the orange curves in FIG. 9(c) depict the AUC gain and the MAE loss reduction, respectively, when synthetic training datasets are used. There is an indication that the up to 0.1 mean AUC gain (i.e., from 0.67 to 0.77) in experiment 2 (Exp. 2) is possible when the training set size is chosen as 3200 and 9600 as the synthetic training data sets, respectively. Overall, the gain increases up to certain extent in training set size (e.g., 3200 training set size), and then decreases again as the training data set size increases further. This may be because an increased training set size helps to improve the model, and thus the generated synthetic dataset does not bring as much as it brought with smaller dataset size. This indicates that there is a sweet spot in the training dataset size. In parallel, if the original data set size is too small, then the generated dataset might be too noisy as it cannot capture the original training data distribution, and hence may yield a lower or no gain in accuracy.

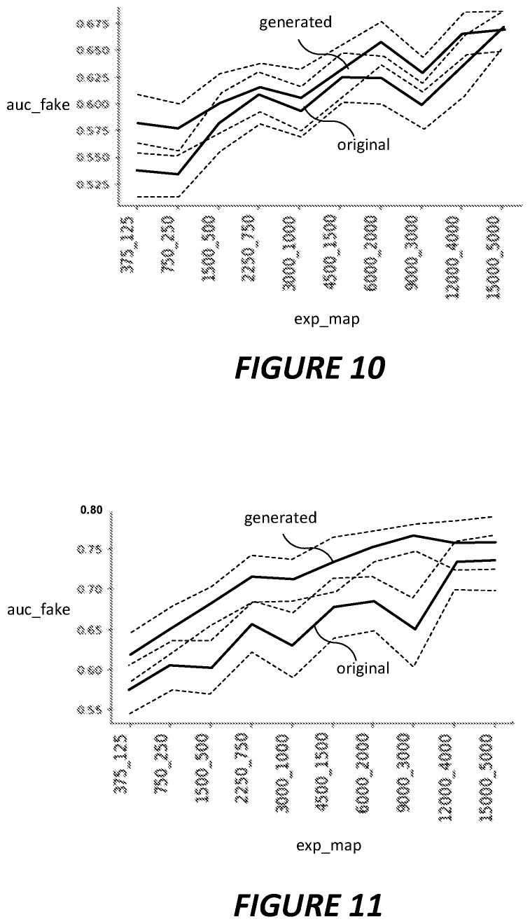

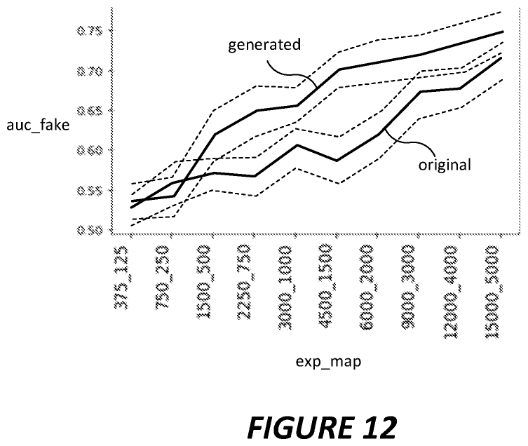

FIGS. 10, 11 and 12 in three datasets A, B and C also indicate that when the training dataset is extended using LOO based tabular data generation, the testset accuracies of the models show statistically significant improvement.

To evaluate whether the LOO approach works in other datasets, a publicly available QoE dataset is chosen. Indicative features related to spatio-temporal video quality such as stalling events and presentation video resolution and bitrate were extracted from the dataset. All columns are quasi-continuous in the dataset. The dataset consists of 9 features as indicative/descriptive features to QoE such as initial bitrate, mean bitrate, nr. Of stalling events, etc. The target variable, the label, is a MOS score in ABR scale (0-100), where the higher scores are rather better QoE than the lower ones. In total there are 450 samples in the whole dataset.

Experiments are performed with varying training set sizes in the range between 50 and 220. The training set size could not be increased to more than 220 due to a need to allocate test and validation sets from a total of 450 samples. When the requested training set size is set to 50, 50 more samples are generated, hence the training set size becomes two times big; 50+50=100. Next a neural network is trained with this higher number of samples, which is a blend of real and synthetic samples. In the below table, the results from the experiments are given, and in overall the overall accuracy of the model is increased, the prediction error is decreased when a higher number of training set is used.

The experiments are repeated 50 times to be able to compare whether the proposed solution works or not within the confidence intervals.

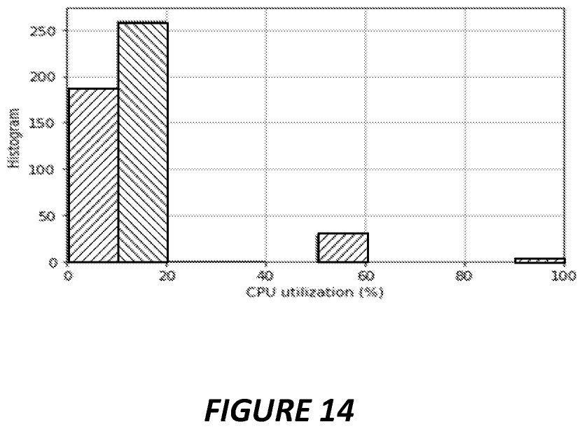

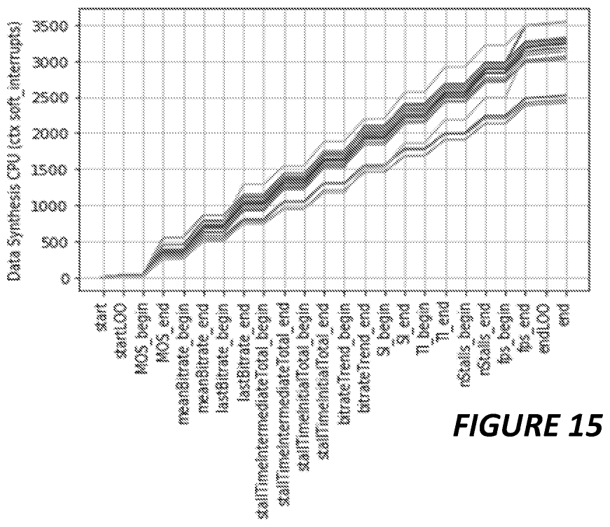

The model accuracy R2 score and the MAE are improved in the case when the synthetically generated tabular dataset is used as the training set to the model as given in Table 3. The MAE decreased and R2 score increased. The computation time of the LOO approach is given in Table 4. The computation time increases linearly with the number of features (see FIG. 10). With the given number of features in the example dataset, e.g., nine features, the total computation time is observed to be around 4 seconds which is rather faster than existing GAN approaches. The CPU utilization shown in FIG. 14 and the number of software interrupts shown in FIG. 15 during computation are significantly less (approx. mean 10%) during the time. The results are summarized in Table 4.

TABLE 3
R2 scores and Mean Absolute Errors are
compared using RF based LOO method

| | MAE (Error) | | R2 (Goodness of fit) | |
|---|---|---|---|---|
| | | Synthetic | | Synthetic |
| Original | Original | training | Original | training |
| Train set | training | set via | training | set |
| size | set | LOO | set | via LOO |
| 50 | 8.67 | 8.16 | 0.44 | 0.49 |
| 100 | 7.07 | 6.73 | 0.63 | 0.66 |
| 150 | 6.50 | 6.14 | 0.70 | 0.72 |
| 200 | 5.99 | 5.83 | 0.73 | 0.75 |
| 220 | 6.00 | 5.80 | 0.75 | 0.77 |

TABLE 4
Indicative comparison of proposed solution with existing GAN
technique used in tabular data generation

| | Software Interrupts | | | | | |
|---|---|---|---|---|---|---|
| | (CPU util %) | | Computation Time | | Accuracy (R2 score) | |
| | Proposed | | Proposed | | Proposed | |
| Train set size | Solution | CTGAN | Solution | CTGAN | Solution | CTGAN |
| 50 | 2615 | 11592 | 3.80 s | 5.13 s | 0.44 → 0.49 | 0.25 |
| | (10.5%) | (46.9%) | | | | |
| 100 | 2550 | 11970 | 3.96 s | 5.83 s | 0.63 → 0.66 | 0.43 |
| | (10.3%) | (44.0%) | | | | |
| 150 | 3146 | 12139 | 4.18 s | 6.04 s | 0.70 → 0.72 | 0.52 |
| | (10.1%) | (42.2%) | | | | |
| 200 | 2678 | 12738 | 4.12 s | 6.35 s | 0.73 → 0.75 | 0.60 |
| | (10.0%) | (41.4%) | | | | |
| 220 | 2676 | 12989 | 4.21 s | 6.43 s | 0.75 → 0.77 | 0.62 |
| | (10.3%) | (40.9%) | | | | |

TABLE 5
KL divergence comparison between proposed
solution and the experimented GAN approach

| Train set | Proposed Solution | CTGAN |
|---|---|---|
| size | KL Div Mean (std) | KL Div Mean (std) |
| 50 | 0.009 (0.01) | 0.024 (0.02) |
| 100 | 0.005 (0.004) | 0.023 (0.01) |
| 150 | 0.004 (0.004) | 0.023 (0.01) |
| 200 | 0.003 (0.003) | 0.022 (0.01) |
| 220 | 0.003 (0.003) | 0.025 (0.02) |

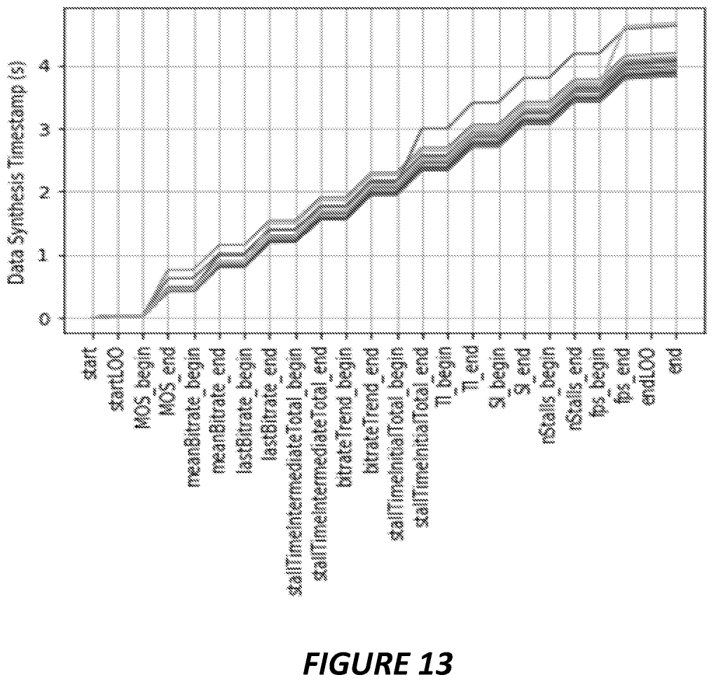

FIG. 13 is a snapshot of computation time during the LOO data synthesis method. The X-axis depicts the state of the computation, e.g., the corresponding time f(feature_end)-f(feature_begin) would yield the time it takes for all the data for the corresponding feature to be generated.

FIG. 14 is a snapshot CPU utilization histogram is during the LOO data synthesis method.

FIG. 15 is a snapshot of software interrupts during the LOO data synthesis method. The X-axis depicts the state of the computation, e.g., the corresponding time f(feature_end)-f(feature_begin) would yield the nr of software interrupts during data generation for the corresponding feature.

For simpler datasets, the model that is used in model generation, i.e., Random Forest, can further be simplified and replaced with a Lasso Regression, i.e., with LinearRegression with L2 regularization to avoid the chance of overfitting.

Hyperparameters of the GAN model used in the experiments are shown in Table 6.

TABLE 6
Hyperparameters of the GAN model

| | |
|---|---|
| embedding dimensions = 64 | l2 normalization scale = 1e−6 |
| 2D data generative model | batch size = 50 |
| dimensions = (128,128) | nr of training steps = 120 |
| 2D Discriminator model | |
| dimensions = (128,128) | |

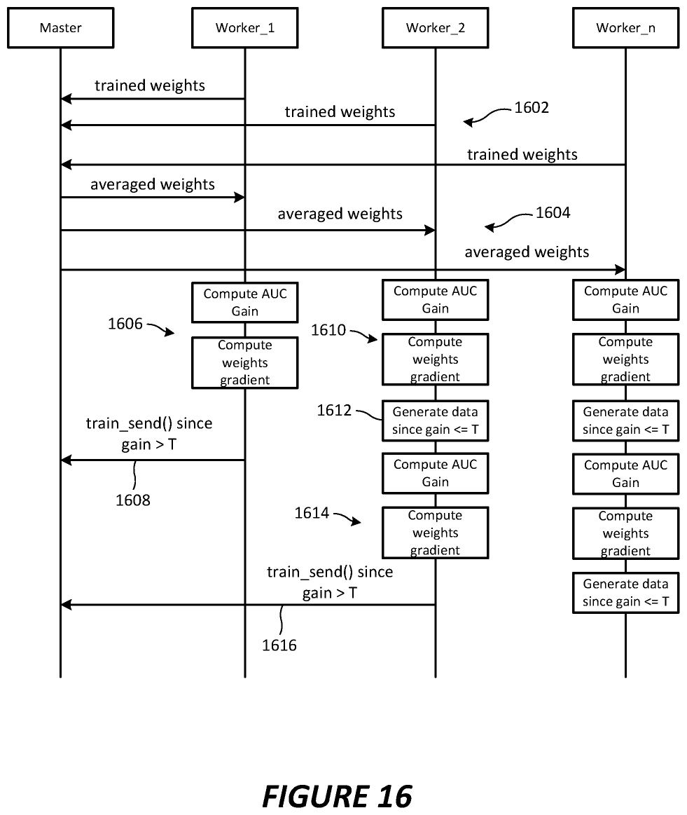

The LOO approach can be integrated to the existing FL POC framework, as an additional function, where this function is “generate_data( )”, instead of “train_send( )”. The master node can orchestrate a worker node to generate synthetic dataset to improve the starting isolated learning accuracy. This is applicable in the cases where the worker does not contribute to the federation (overall model accuracy during FL due to its noisy starting model), and is instead asked to generate its own data up to certain accuracy threshold. This applies for a temporary period of time, where for instance in the cases a worker does not have enough data to train and join the federation in the early phases, hence is first asked to generate a data up to a certain quality and quantity and only after that is allowed to join the federation as shown in FIG. 16.

Referring to FIG. 16, three workers (Worker_1, Worker_2, W0rker_3) generate and send trained weights to a master (1602). The master averages the weights and sends the averaged weights to the workers (1604). Worker_1 computes an AUC gain and a weights gradient (1606). Since the AUC gain for Worker_1 is greater than a threshold T, Worker_1 sends the trained weights to the master (1608). Worker_2 also computes the AUC gain and weights gradient (1610). However, since the AUC gain for Worker_2 is initially less than the threshold T, Worker_2 generates additional training data (1612), and then repeats operations of computing AUC gain and the weights gradient (1614). This time, the AUC gain is greater than the threshold T, so Worker_2 sends the trained weights to the master (1616).

The LOO approach is also applicable in the cases where the worker does not benefit from overall FL model being learned collaboratively. This may happen when a worker's data distribution is significantly different from the majority of the other workers data distribution. In that case, the worker can choose to generate more dataset from its own distribution, and can still improve its model performance accuracy while being trained in an isolated manner. An example case, even if worker n in FIG. 16 would not benefit from federation, its accuracy is still expected to improve through use of the additional synthetic training dataset, and can continue training as an isolated node.

Abbreviations
AUC Area Under the Curve
CL Collaborative Learning
FL Federated Learning
GAN Generative Adversarial Network
GBM Gradient Boosting Machine
GDPR General Data Protection Regulation
IPR Intellectual Property Rights
KL Kullback-Leibler
LGBM Light Gradient Boosting Model
LOO Leave-One-Out
MAE Mean Absolute Error
MSE Mean Squared Error
ML Machine Learning
NN Neural Network
QoE Quality of Experience
RF Random Forest
RNN Recurrent Neural Network
XGBoost Extreme Gradient Boosting

### REFERENCES

Athula Balachandran and et al., “Developing a predictive model of quality of experience for internet video,” in ACM SIGCOMM Computer Communication Review. ACM, 2013, vol. 43, pp. 339-350.
H. Brendan, et.al, Communication-Efficient Learning of Deep Networks from Decentralized Data, 2016. Online, available at: https://arxiv.org/abs/1602.05629.
S. Ickin, K. Vandikas, M. Fiedler, Privacy Preserving QoE Modeling Using Collaborative Learning, Internet-QoE′19: Proceedings of the 4th Internet-QoE Workshop on QoE-based Analysis and Management of Data Communication Networks, October 2019 Pages 13-18, 2019.
Raghunathan, T. E., Lepkowski, J. M., van Hoewyk, J., and Solenberger, P. (2001) A multivariate technique for multiply imputing missing values using a series of regression models, Survey Methodology 27 85-96.
Gregory Caiola and Jerome P. Reiter. 2010. Random Forests for Generating Partially Synthetic, Categorical Data. Trans. Data Privacy 3, 1 (April 2010), 27-42.
Ian J. Goodfellow, et. al, Generative Adversarial Networks. ArXiv 2014. Available at: https://arxiv.org/abs/1406.2661.
DP. Kingma, M. Welling, Auto-Encoding Variational Bayes, Proceedings of the 2nd International Conference on Learning Representations (ICLR), 2014.
L. Xu, M. Skoularidou, A. Cuesta-Infante, K. Veeramachaneni, Modeling Tabular data using Conditional GAN, 33rd Conference on Neural Information Processing Systems, Vancouver, Canada, 2019.
E. Jeong, et. al., Communication-efficient On-device Machine Learning: Federated Distillation and Augmentation under Non-iid Private Data. NIPS Workshop, Montreal, Canada, 2018.
R. Schatz and S. Egger, An Annotated Dataset for Web Browsing QoE. In: 6th International Workshop on Quality of Multimedia Experience (QoMEX), September 18-20, Singapore, 2014.
Z. Duanmu, A. Rehman, and Z. Wang, “A Quality-of-Experience Database for Adaptive Video Streaming,” IEEE Transactions on Broadcasting, Vol. 64/2, 2p. 474-487 June, 2018
Kaggle, House Prices: Advanced Regression Techniques. Online, available at: https://www.kaggle.com/c/house-prices-advanced-regressiontechniques.
Z. Duanmu, A. Rehman, and Z. Wang, “A Quality-of-Experience Database for Adaptive Video Streaming,” IEEE Transactions on Broadcasting, 64(2):474-487, 2018.
Breiman, L., Friedman, J. H., Olshen, R. A., and Stone, C. J. (1984) Classification and Regression Trees, Belmont, Calif.: Wadsworth, Inc.
Leo Breiman. Bagging predictors. Machine Learning, 24(2):123-140, August 1996.
Noseong Park, et al. Data synthesis based on generative adversarial networks. Proc. VLDB Endow. 11, 10 (June 2018), 1071-1083. DOI: https://doi.org/10.14778/3231751.3231757

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of generating a synthetic training dataset for training a machine learning model using an original training dataset including a plurality of features, the method comprising:
selecting (404) a feature cᵢ of the original training dataset as a target vector yᵢ;
selecting (406) remaining features of the original training dataset as a set of training input vectors X_{\i}, where X_{\i} includes all features of the training dataset other than a feature corresponding to the selected feature cᵢ;
training (408) a prediction model f(yᵢ|X_{\i});
generating (410) an estimate y′ᵢ of the target vector yᵢ by applying the prediction model to the set of training vectors X_{\i}; and
inserting (412) a synthetic feature c′ᵢ corresponding to the estimate y′ᵢ of the target vector yᵢ into a synthetic training dataset.

2. The method of claim 1, further comprising:
repeating, for a plurality of features of the original training dataset, operations of selecting a feature of the training dataset, selecting remaining features of the training dataset, training the prediction model, generating the estimate of the target vector and inserting the synthetic feature into the synthetic training dataset.

3. (canceled)

4. The method of claim 1, wherein the prediction model comprises a bagging or boosting algorithm.

5. The method of claim 1, wherein the prediction model comprises a random forest prediction model or gradient boosting tree model.

6. The method of claim 1, wherein generating the estimate y′ᵢ of the target vector yᵢ comprises running an inference on the prediction model using the set of training vectors X_{\i}.

7. The method of claim 1, wherein generating the estimate y′ᵢ of the target vector yᵢ comprises:
generating an estimate y′ᵢ of the target vector yᵢ by applying the prediction model as f(X_{\i})->y′ᵢ.

8. The method of claim 1, further comprising:
appending the synthetic training dataset to the training dataset to form a hybrid training dataset; and
training a machine learning model using the hybrid training dataset.

9. The method of claim 8, wherein the machine learning model comprises a neural network.

10. The method of claim 8, wherein appending the synthetic training dataset to the training dataset to form the hybrid training dataset training the machine learning model are performed in response to an indication from a master node in a federated learning system.

11. The method of claim 10, wherein training the machine learning model comprises generating trained weights for a neural network, the method further comprising transmitting the trained weights to the master node.

12. The method of claim 8, further comprising:
providing a preliminary training dataset;
splitting the preliminary training dataset into the training dataset and a verification dataset before generating the synthetic training dataset;
verifying the neural network using the verification dataset;
performing feature reduction on the preliminary training dataset before splitting the preliminary training dataset into the training dataset and the verification dataset; and
sorting the preliminary training dataset in descending order according to an importance of the features.

13-14. (canceled)

15. The method of claim 1, further comprising:
computing a Kullback-Leibler divergence between the training dataset and the synthetic training dataset to determine a quality of the training dataset.

16-22. (canceled)

23. A computing device, comprising:
a training dataset collection module that obtains a training dataset, the training dataset comprising a plurality of features; and
a synthetic dataset generation module that generates a synthetic training dataset by performing operations including:
selecting a feature cᵢ of the training dataset as a target vector yᵢ;
selecting remaining features of the training dataset as a set of training vectors X_{\i}, where X_{\i} includes all features of the training dataset other than feature cᵢ;
training a prediction model f(yᵢ|X_{\i});
generating an estimate y′ᵢ of the target vector yᵢ by applying the prediction model to the set of training vectors X_{\i}; and
inserting a feature c′ᵢ corresponding to the estimate y′ᵢ of the target vector yᵢ into the synthetic training dataset.

24-27. (canceled)

28. A method of operating a master in a federated learning system including a plurality of workers that communicate with the master via a message bus, the method comprising:
transmitting, via the message bus, a message to at least one of the workers instructing the at least one worker to generate synthetic training data; and
receiving, via the message bus, model parameters of a machine learning model from the at least one worker that were generated using the synthetic tabular training data;
wherein the model parameters received from the worker comprise trained neural network weights.

29. (canceled)

30. The method of claim 29, further comprising:
receiving from the at least one worker a set of preliminary neural network weights that were trained without using the synthetic training data; and
evaluating the set of preliminary neural network weights;
wherein transmitting the message to the at least one worker instructing the at least one worker to generate synthetic tabular training data is performed in response to evaluating the set of preliminary neural network weights.

31. The method of claim 28, further comprising:
after instructing the at least one worker to generate the synthetic training data, receiving a quality metric from the at least one worker, wherein the quality metric measures a quality of the synthetic training dataset; and
instructing the worker to proceed with training a machine learning model using the synthetic training dataset in response to the quality metric.

32-33. (canceled)

34. A master node in a federated learning system comprising:
a processing circuit; and
a memory coupled to the processing circuit, wherein the memory comprises computer readable program instructions that, when executed by the processing circuit, cause the master node to perform operations according to claim 28.

35-36. (canceled)
